(19) United States
(12) Patent Application Publication
(10) Pub. No.: US 2024/0218218 A1
(43) Pub. Date: Jul. 4, 2024

(54) OPTICALLY CLEAR UV AND THERMAL CURING EPOXY COMPOSITIONS

(71) Applicant: Henkel AG & Co. KGaA, Duesseldorf (DE)

(72) Inventors: Dingsong Feng, Needham, MA (US); Zhan Hang Yang, Rocky Hill, CT (US); Jiangbo Ouyang, Wallingford, CT (US)

(21) Appl. No.: 18/605,702

(22) Filed: Mar. 14, 2024

Related U.S. Application Data
(63) Continuation of application No. PCT/US22/43411, filed on Sep. 14, 2022.
(60) Provisional application No. 63/261,184, filed on Sep. 14, 2021.

(51) Int. Cl. C09J 163/00; C09J 11/06

(52) U.S. Cl. CPC C09J 163/00; C09J 11/06

(57) ABSTRACT

Adhesive compositions having optical clarity are disclosed. The compositions include saturated epoxy-functionalized compound; a heat cure system which includes an alicyclic anhydride and a cationic catalyst; a predominantly hydrophobic cross-linking (meth)acrylate in amounts sufficient to control the crosslinking density of the composition; and a photoinitiator to allow for initial fixturing of the composition prior to thermal cure. The compositions provide an optical transmittance of at least 95% and a yellowness (*b) of <1%.

### TECHNICAL FIELD

The present disclosure relates to optically clear epoxy compositions which are both ultra-violet (UV) curable and thermally curable and which retain their optical clarity over time such that they are useful in optical applications.

### BACKGROUND

Epoxy compositions typically require components such as inorganic fillers or pigments which are included as viscosity modifiers to accommodate various end uses as well as to enhance such physical properties as strength, durability and enhancing shrinkage resistance, among others. For example, silica, glass fibers, and cellulosic such as wood are common epoxy filers. For example, US Patent Application Publication US20110298003A1 describes an epoxy resin composition for optical use which incorporates an epoxy resin, a curing agent, and inorganic filler which has as refractive index larger than a refractive index of the cured product obtained when the inorganic filler is excluded. Unlike the present invention, this prior composition requires a filler component.

While fillers provide advantages to traditional epoxy resin systems, they are not typically useful for applications which require the composition to be initially optically clear and remain so over time, i.e., resist yellowing over time.

Initiator free, one part compositions containing hybrid epoxy adhesives are described in “High Performance UV and Thermal Cure Hybrid Epoxy Adhesive,” IOP Conference on Polymer and Composite Materials (PCM 2017). This article describes a hybrid composition which contains a bismaleimide compound, a partially acrylated bisphenol A epoxy resin, an acrylic monomer, an epoxy resin and a latent curing agent. This paper discuss that good results of both UV and thermal curing were obtained.

Epoxy-based compositions typically do not provide sufficient optical clarity to be used in applications which require substantial optical transparency/translucency, i.e., the ability to allow one to see through the cured material and to allow light to pass through. This may be due to the inherent opaqueness of the materials used, including the selection of epoxy materials, inorganic fillers and other light blocking additives, the choice of cure systems and other additives, all of which contribute to the optical clarity or lack thereof over time. Although viscosity modifiers allow for control of the viscosity and rheology of the compositions in order to prevent unwanted migration of the composition once deposited on the intended substrate, they are generally deleterious to the optical clarity. The same is true for aromatic epoxies or epoxies which contain oxidizable groups. These epoxies do not possess the optical clarity initially nor over time due to the oxidative effects on the functional groups. Additionally, light curing mechanisms are generally not effective in compositions where due to the incorporation of light-blocking components, light cannot effectively penetrate to initiate cure or obtain full cure.

Yellowing over time is undesirable and as mentioned may be attributable to oxidation effects. To eliminate yellowness over time, the invention seeks to minimize the potential for oxidation and consequently the presence of double bonds or other groups that may easily oxidize over time. So the selection of each of the components for the present invention is made with this in mind.

Presently, there is a need for epoxy compositions which curable using UV and thermal cure, which are initially optically clear and remain so over time, and which do not require additional components such as fillers or viscosity modifiers to enhance or obtain their strength. Desirably, such compositions also exhibit strong adhesive properties, chemical resistance and a range of flexibility properties.

### SUMMARY

The present disclosure provides a solution to the problems discussed above, and offers the advantages of balancing excellent optical clarity with chemical resistance, strength and flexibility, as well as other advantages known to those skilled in the art. The present disclosure provides epoxy compositions which have optical clarity initially and over time. The composition may be initially subjected to UV curing to fixture the composition, thus controlling the composition's deposition on a substrate. Initial fixturing (i.e. tackifying) allows for further handling in the manufacturing/assembly process without concern for adhesive migration. Once the composition is initially fixtured using UV exposure, thermal curing mechanisms/conditions may be employed to fully cure the composition. The ability to employ UV curing mechanisms allows for initial tackifying of the adhesive when deposited, which alleviates viscosity control problems during deposition, As mentioned above, conventionally, viscosity modifiers such as fillers where required in order to control deposition and migration of the adhesive during use. Full cure may be obtained by subjecting the adhesive to thermal conditions. The optically clear (i.e. substantially transparent or substantially translucent) epoxy compositions of the inventive disclosure may formulate into one-part or two part compositions and used in a variety of applications, particularly optical applications, such as optical semiconductor elements, display modules, camera modules and other optical applications.

The inventive disclosure includes an adhesive composition having optical clarity which includes:
a) a saturated epoxy-functionalized compound;
b) a heat cure system including an alicyclic anhydride and a cationic catalyst;
c) a cross-linking (meth)acrylate in amounts sufficient to control the crosslinking density of the composition; and
d) a photoinitiator;
wherein the cured composition provides an optical transmittance of at least 95% and a yellowness (*b) of <1%. This optical transmittance correlates to optical clarity.

The inventive compositions may also include a two part epoxy adhesive composition including: a first part including: a saturated epoxy-functionalized compound; a cationic catalyst; a photoinitiator; and a second part including: a crosslinking (meth)acrylate and an alicyclic anhydride, wherein the cured composition provides an optical transmittance of at least 95% and a yellowness (*b) of <1%.

The inventive compositions may also include a method of making an adhesive composition including; mixing together components including a saturated epoxy-functionalized compound; an alicyclic anhydride; a cationic catalyst; a crosslinking (meth)acrylate and a photoinitiator; wherein the cured composition provides an optical transmittance of at least 95% and a yellowness (*b) of <1%.

The inventive compositions may also include an adhesive product formed by the process of: (i) forming a mixture including a saturated epoxy-functionalized compound; a cationic catalyst; an alicyclic anhydride; a crosslinking (meth)acrylate and a photoinitiator; (ii) Subjecting the mixture to UV energy to cause free radical polymerization of the crosslinking (meth)acrylate to partially cure the mixture; and (iii) further subjecting the partially cured mixture of step (ii) to heat cure to form a product having an optical transmittance of at least 95% and a yellowness (*b) of <1%.

### DETAILED DESCRIPTION

For purposes of the present inventive disclosure, the term (meth)acrylate(s) will include methacrylate(s) and acrylate(s).

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

The terms “comprising” and “comprises” as used herein are synonymous with “including”, “includes”, “containing” or “contains”, and are inclusive or open-ended and do not exclude additional, non-recited members, elements or method steps.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

When amounts, concentrations, dimensions and other parameters are expressed in the form of a range, a preferable or desired range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably or desired and desirably are used frequently herein to refer to embodiments of the disclosure that may afford particular benefits, under certain circumstances. However, the recitation of one or more preferable or preferred, desired or desirable embodiments does not imply that other embodiments are not useful and is not intended to exclude those other embodiments from the scope of the disclosure.

Unless specifically noted, throughout the present specification and claims the term molecular weight when referring to a polymer refers to the number average molecular weight (Mn) of that polymer. The number average molecular weight Mₙ can be calculated based on end group analysis (OH numbers according to DIN EN ISO 4629, free NCO content according to EN ISO 11909) or can be determined by gel permeation chromatography according to DIN 55672 with THE as the eluent. If not stated otherwise, all given molecular weights are those determined by gel permeation chromatography.

The inventive compositions include an epoxy-based composition having a combination of components which have been demonstrated to achieve a balance between excellent mechanical and chemical resistances, while maintaining optical clarity and clear color over time. These components include: (1) a saturated epoxy-functionalized compound; (2) a heat cure system including (i) an alicyclic anhydride and (ii) a cationic catalyst; (3) a cross-linking (meth)acrylate in amounts sufficient to control the crosslinking density of the composition; and (4) a photoinitiator.

When cured, the composition provides an optical transmittance of at least 95% and a yellowness (*b) of at least <1%. The composition possesses a number of very useful properties and advantages, among which include a range of flexibilities which can be tailored by adjusting the crosslinking component, as well chemical resistance in alcohol after 72 hr at 65° C., as demonstrated by block shear testing results of about 9 MPa or greater.

The selection of components for the present compositions is made such that the starting materials are as optically clear as possible (meeting the Optical Clarity requirements) and do not contribute to yellowing over time such that the optical clarity is unacceptable.

### Epoxy Functionalized Component

The inventive compositions include a saturated epoxy-functionalized compound. Use of unsaturated epoxy-functionalized compounds has been found to either lack sufficient initial clarity for optical applications, to yellow prematurely over time, or both. Thus, the inventors have discovered that the use of saturated epoxy-functionalized compounds provide optical clarity both initially and over time.

Examples of classes of useful saturated epoxy-functionalized compounds include hydrogenated bisphenol A epoxy resins, hydrogenated bisphenol F epoxy resins, cycloaliphatic epoxy resins and combinations thereof.

Commercially available examples of such saturated compounds include Hexion Eponex 1510; Denacol 252, JER YX8034; Jer YX8000; Jer YX8000D; and Jer YX8040.

Useful saturated cycloaliphatic epoxy-functionalized compounds include: EPALLOY 8220, and Dow CYRACURE UVR-6110 cycloaliphatic epoxide; and multi-functional cycloaliphatic epoxy resins such as EHPE3150.

Additionally, useful commercially available saturated epoxy-functionalized compounds which have enhanced toughness and elongation properties include: Nisso-JP100/200, PolyBD 605E, Adeka EPU73B, YX7400, Kaneka MX series, JER specialty YX-7400 and combinations thereof.

The saturated epoxy-functionalized compounds may be present in amounts of about 60% to about 80% based on the weight of the total composition.

### Heat Cure System (Alicyclic Anhydride and Cationic Catalyst)

The inventive compositions include a thermal (heat) cure system which includes an alicyclic anhydride and a cationic catalyst. Liquid alicyclic anhydrides are used in the inventive compositions, as opposed to aromatic anhydrides. It has been determined that aromatic anhydrides are not useful because they do not allow for the required optical clarity, neither initially nor overtime.

Examples of useful alicyclic anhydrides include tetrahydrophthalic anhydride (THPA), hexahydrophthalic anhydride (HHPA), methyltetrahydrophthalic anhydride (MTHPA), methylhexahydrophthalic anhydride (MHHPA), nadic methyl anhydride (NMA) and combinations thereof. The anhydride may be present in amounts of about 15% to about 40% by weight based on the total composition, more desirably in amounts of about 20% to about 35% by weight based on the total composition, and even desirably in amounts of about 25% to about 30% by weight based on the total composition. The anhydride/epoxy resin ratio may be about 1.1 to about 0.7 and more desirably about 0.85 to about 0.95.

The cationic catalyst may be selected from non-amino catalysts, non-imidazole-containing catalysts and combinations thereof. Examples of useful catalysts include those selected from zinc catalysts, tin catalysts and phosphine catalysts. Specific examples of useful catalysts include, without limitation, tributylmethylammoniumbromide, tributyl(methyl)phosphonium dimethyl phosphate, and combinations thereof. The cationic catalyst may be present in amounts sufficient to effectively catalyze the thermal curing, but generally may be present in amounts of about 0.1% to about 2% by weight of the total composition, more desirably in amounts of about 0.2% to about 1% by weight of the total composition, and even more desirably in amounts of about 0.4% to about 0.8% by weight of the total composition.

### Cross-Linking (Meth)Acrylate Component

The inventive compositions include a predominantly non-polar cross-linking (meth)acrylate in amounts sufficient to control the crosslinking density of the composition and obtain the desired chemical resistance and flexibility properties. Predominantly non-polar means that the (meth)acrylate contains no more than 10 hydroxy or alkoxy groups which contribute to poor chemical resistance due to their hydrolysis. Desirably, the cross-linking (meth)acrylate component is relatively non-polar, i.e., more hydrophobic than hydrophilic. It has been determined that this allows for increased alcohol and water aging stability than more polar materials would provide. Desirably, the cross-linking (meth)acrylate provides excellent chemical resistance, as well as enhanced flexibility and elongation properties. The inventive compositions allow for a balance between flexibility and maintaining chemical resistances by carefully selecting the amounts of the cross-linking (meth)acrylate to control the crosslinking density. It is also important that the choice of cross-linking (meth)acrylate be compatible with the epoxy compound in order to maintain a single phase composition and prevent separation. The amount of the cross-linking (meth)acrylate has significant impact on adhesion, chemical resistance and flexibility and modulus. The cross-linking (meth)acrylate generally may be present in amounts of about 15% to about 45 by weight of the total composition, more desirably in amounts of about 20% to about 40% by weight of the total composition, even more desirably in amounts of about 25% to about 35% by weight of the total composition.

Noon-limiting examples of useful crosslinking (meth)acrylates include those selected from bisphenol A ethoxylate diacrylate, polyurethane-trimethylolpropane tri(meth)acrylate, diethylene glycol di(meth)acrylate, triethylene glycol di(meth)acrylate, polyethylene glycol di(meth)acrylate, di(pentamethylene glycol)di(meth)acrylate, diglycerol diacrylate, diglycerol tetra(meth)acrylate, butylene glycol ethoxylated tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polybutadiene-polyurethane-acrylate block copolymers, polyurethane-acrylate block copolymers, polyurethane-silicone-acrylate copolymers and combinations thereof.

The crosslinking (meth)acrylate component may be present in various amounts in order to control the degree of crosslinking and thus contribute to control of such properties as flexibility and chemical resistance. Generally, the crosslinking (meth)acrylate may be present in amounts of about 15% to about 45% by weight of the total composition, desirably about 20% to about 40% by weight of the total composition and even more desirably about 25% to about 35% by weight of the total composition. Most desirably, the amount of crosslinking (meth)acrylate is adjusted within these ranges to obtain the desired degree of crosslinking and hence the desired flexibility and chemical resistance.

The crosslinking (meth)acrylate component desirably has a glass transition temperature (Tg) of about −40° ° C. to about 60° C., and more desirably from about −40° C. to about 10° C.

### Photoinitiator Component

As with the other components selected for the inventive compositions, the photoinitiator component must be selected to be substantially clear and stable, i.e., not contribute to yellowing or color change over time. Useful photoinitiators classes include benzoin ketals, hydroxyketones, acylphosphine peroxides, and any combination thereof. Specific examples of useful photoinitator compounds include hydroxycyclohexyl phenyl ketone, 2,2-dimethoxyl-1,2-diphenylethyl-1-ketone, trimethylbenzoyldi-phenyl oxyphosphate, 1-hydroxylcyclohexyl benzophenone, 2-methyl1-[4-methylthiaphenyl]-2-dimethylthia-propyl-1-ketone and combinations thereof.

The photoinitiator may be present in amounts of about 0.05% to about 5% based on the weight of the total composition, desirably in amounts of about 0.1% to about 3% based on the weight of the total composition and even more desirably in amounts of about 0.2% to about 0.5% based on the weight of the total composition.

### Additives

The compositions of the present disclosure may include a variety of additional components, selected to modify the mechanical and chemical properties of the final products without deleteriously affecting the optical clarity initially or overtime. Thus, materials which contribute to color or which color or yellow over time are not desirable.

For example, the inventive compositions may further include a mono-(meth)acrylate selected from isobornyloxyethyl (meth)acrylate, isobornyl (meth)acrylate, 2-ethylhexyl (meth)acrylate, ethyldiethylene glycol (meth)acrylate, t-octyl (meth)acrylamide, diethylaminoethyl (meth)acrylate, lauryl (meth)acrylate, dicyclopentadiene (meth)acrylate, dicyclopentenyloxyethyl (meth)acrylate, dicyclopentenyl(meth)acrylate, tetrahydrofurfuryl (meth)acrylate, 2-hydroxyethyl (meth)acrylate, 2-phenoxyethyl (meth)acrylate, butoxyethyl (meth)acrylate and combinations thereof.

Block resins such as polybutadiene urethane acrylate series BR-640D, 641D, 641E, 643 are useful additives in the present inventive disclosure. Particular examples which are useful include SR833S and SR348. BR-640D, 641D, 641E, 643 are available from Dymax Corporation, Torrington, CT, polybutadiene (PBd) urethane acrylate oligomers having a functionality of two. These materials are highly hydrophobic.

The compositions are LED cured to fixture for 10 to 50 seconds, and heat cured for 30 to 70 minutes.

### Optical Properties

The inventive compositions were designed to possess the following optical properties:

$$\begin{matrix}a ) & transmittance : > 94 \% \\ b ) & b * < 1 \% \\ c ) & haze < 1.\end{matrix}$$

Optical properties were measured as follows: Laminated samples of each of the inventive compositions were prepared by placing a layer of adhesive between two glass slides, the layer having a coating thickness of 12.5 mil which is about 318 microns (u), then fixture curing the adhesive by LED cure, followed by heat cure as described previously. After the samples were fully cured, they were tested for transmittance, haze and the yellowness b* value using a Datacolor 650 apparatus available from Datacolor Corporation, in compliance with ASTM D1003.

### Examples

Tables 1 and 2 below shows inventive compositions. Table 1 shows a 2 part inventive compositions (A) and Table 2 shows 1 part compositions (C-E). Test results for these compositions are shown in Table 3.

Block shear tests were run substantially in accordance with ASTM D 905-08 (2008) “Strength Properties of Adhesive Bonds in Shear by Compression Loading.” (1″×1″ glass with quarter inch overlap).

The following Mechanical/Properties are considered acceptable and desirable for the compositions of the present invention:

A tensile strength of >20 MPa is desirable; with respect to elongation, at least >2% and desirably >10% elongation is desirable. A Modulus of >400 MPa is desirable. Chemical Aging Adhesion Properties: >15 MPa Initially (before aging); and >10 MPa after chemical aging.

TABLE 1
Inventive One Part Compositions

| | Composition | | |
|---|---|---|---|
| | A | B | C |
| | DF-46A | F-46B | F-57C |
| Constituents | % wt | % wt | % wt |
| Saturated Non-aromatic epoxy | 38.83 | 42.68 | 21.44 |
| (Eponex 1510) | | | |
| Saturated non-aromatic epoxy | — | — | 21.44 |
| (JP-200) | | | |
| MPPHA | 25.94 | 28.51 | 28.26 |
| Cationic Catalyst | — | | 0.39 |
| (Tributyl(methyl)phosphonium | | | |
| dimethyl phosphate) | | | |
| Cationic Catalyst | 0.37 | 0.39 | |
| (Tributylhexadecylphosphonium | | | |
| bromide) | | | |
| Predominantly Non-polar | — | 25.61 | 25.73 |
| Cross-linking | | | |
| (Meth)acrylate (SR348) | | | |
| Cross-linking (Meth)acrylate (SR348) | 27.77 | | |
| Cross-linking (Meth)acrylate (SR833) | 3.01 | 0.00 | |
| Photoinitiator (Irgacure 184) | 0.37 | 0.39 | |
| Photoinitiator (Irgacure 184) | — | — | 0.39 |
| Lauryl acrylate | 3.32 | 2.03 | 2.04 |
| Adhesion Promoter (Z 6040 Silane) | 0.19 | 0.20 | 0.16 |
| UV absorber (Tinuvin 292) | 0.19 | 0.20 | 0.16 |

TABLE 2
Inventive One Part Compositions Test results

| Composition | A | B | C |
|---|---|---|---|
| Chemistry | 1 part | 1 part | 1 part |
| | Epoxy | Epoxy | Epoxy |
| | hybrid | hybrid | hybrid |
| Cure (fixture/Thermal) | UVT (160 C. | VT (160 C. | UVT (160 C. |
| | 60 min) | 60 min) | 60 min) |
| Viscosity (cps) at 25° C. | 1200 initial | 1300 initial | 1200 initial |
| Tensile Modulus (MPa) | 2470 | 2520 | 2920 |
| Tensile Strength (MPa) | 68.4 | 66.9 | 77.4 |
| Elongation (%) | 3.6% | 3.6% | 5.4% |
| Tg ° C. | 107 | 106 | 107 |
| Optical | | | |
| Transmittance | 98% | 98% | 92% |
| Yellowness factor b* | 0.36 | 0.35 | 0.36 |
| Haze | 0.3 | 0.4 | 0.9 |
| Adhesion/ | | | |
| Chemical aging* | | | |
| Initial | 18.1 ± 6.24 | 17.7 + 8.25 | 22.5 + 11.4 |
| heat (160° C. 90 min) | 19.1 + 6.86 | 14.9 + 6.50 | 21.3 + 7.31 |
| IPA/water 65° C. 72 h | 6.34 + 2.10 | 13.0 + 11.3 | 9.69 ± 4.38 |
| Ethanol/water 65° C. 72 h | 6.39 ± 2.03 | 16.0 + 6.59 | 9.00 + 3.21 |

*Tensile, Modulus and Elongation tests were run substantially in accordance with ASTM 882
As indicated by the test results, the inventive compositions met the required optical clarity measurements as well as the chemical resistance and mechanical requirements of the invention.

### Comparative Compositions

The following comparative two part composition was formulated in accordance with the inventive method of preparation as discussed herein, and tested for tensile strength (Mpa), tensile modulus (Mpa) and % elongation, as well as measuring the adhesive properties under different conditions. The adhesion tests showed delamination from the substrate and consequently failed as a useful formulation. This is largely attributed to polar groups in the EPON 863 epoxy, which delaminated in IPA/water thermal immersion, which indicates deliberate reagent choice is important for chemical resistance.

A one part comparative Composition D was also formulated and is as shown in Table 3 below. The compositions were tested with the results being shown in Table 4 below. Although the chosen epoxy was saturated, the crosslinking (meth)acrylate was too polar (a total of 13 alkoxy groups in the total acrylate components) and these hydrophilic groups on the (meth)acrylate are believed to contribute to the delamination in chemical immersion testing and are thus not part of the invention.

A two part comparative Composition E was formulated and is as shown in Table 5. The test results for Composition F are shown in Table 6. As reflected in the test results, this composition failed in mechanical testing as well as in optical clarity requirements.

TABLE 3
Composition D (One Part Comparative) (DF40AA)

| | Amount |
|---|---|
| Constituents | (% wt) |
| Aromatic diglycidyl ether of hydrogenated | 30.07 |
| bisphenol A epoxy resin (Eponex 1510) | |
| Methylhexahydrophthalic anhydride (MPPHA) | 20.09 |
| Cationic Catalyst | 0.40 |
| (Tributylhexadecylphosphonium bromide) | |
| Crosslinking (meth)acrylate (SR348 | 15.03 |
| (3EO-meaning 3 alkoxy groups) | |
| Crosslinking (meth)acrylate (SR480) | 30.07 |
| (10EO-meaning 10 alkoxy groups) | |
| UV photoinitiator 1-hydroxycyclohexyl | 0.40 |
| phenyl ketone photoinitiator (PI-184) | |
| Lauryl acrylate | 3.61 |
| Glycidoxypropyltrimethoxysilane adhesion | 0.17 |
| promoter (Dowsil Z 6040 silane) | |
| UV Absorber (Tinuvin 292) | 0.17 |
| | 100.00 |

TABLE 4
Composition D Test results (One Part Comparative) (DF40A)

| Chemistry | 1k UV + Heat |
|---|---|
| Cure (Fixture/Thermal) | UVT (160 C. 60 min) LED cure |
| | for 10 to 50 second, and |
| | Heat cure 60 to 70 min. |
| Viscosity (cps, at 25° C.) | 700 |
| Tensile Modulus (MPa) | 936 |
| Tensile Strength (MPa) | 33.8 |
| Elongation (%) | 19.5 |
| Tg ° C. | 70 |
| Adhesion, MPa | |
| Initial | 16.2 ± 5.48 |
| Isopropyl Alcohol/water | delaminated |
| 65° C. 72 h | |
| Ethanol/water | delaminated |
| 65° C. 72 h | |

TABLE 5
Two Part Comparative E (DF-32A)

| | | Amount |
|---|---|---|
| Part A | Constituents | (% wt) |
| | Aromatic Unsaturated | 27.54 |
| | Epoxy Resin (EPON 863) | |
| | Flexible Epoxy Resin | 4.87 |
| | (JER YX7400) | |
| | Cationic Catalyst | 1.88 |
| | (Hycat AO-4) | |
| | Crosslinkable | 11.55 |
| | polybutadiene | |
| | urethane acrylate | |
| | Photoinitiator | 0.38 |
| | (Irgacure 184) | |
| | 1,4-CyclohexanedimethanolMonoacrylate | 3.38 |
| | (CHDMMA) | |
| | Glycidoxypropyltrimethoxysilane | 0.20 |
| | adhesion promoter (Dowsil Z | |
| | 6040 silane) | |
| | UV Absorber | 0.20 |
| | (Tinuvin 292) | |

| | | Percent |
|---|---|---|
| Part B | Component | Weight |
| | MPPHA (Methylhexahydrophthalic | 26.05 |
| | anhydride) | |
| | Cross-linkable polybutadiene | 23.95 |
| | urethane acrylate | |

TABLE 6
Comparative Composition E Test results
(Two Part Comparative) (DF-32A)

| Chemistry | 2 part UV + Heat (UVT) |
|---|---|
| Cure (Fixture/Thermal) | UVT (120° C. 30 min) LED cure |
| | for 10 to 50 second, and |
| | Heat cure 30 to 60 min. |
| Initial Viscosity (cps, at 25 C.) | ~8000 |
| Tensile Modulus (Mpa) | 936 |
| Tensile Strength (Mpa) | 33.8 |
| Elongation (%) | 19.5 |
| Tg° C. | 70 |
| Adhesion, Mpa | |
| Initial | 20.7 ± 5.31 |
| IPA/water 65 C. 72 h | delaminated |
| Ethanol/water 65 C. 72 h | delaminated |
| Optical | |
| Transmittance | <94% |
| Yellowness factor b* | b* > 1% |
| Haze | >1% |

1. An adhesive composition having optical clarity comprising:
a) a saturated epoxy-functionalized compound;
b) a heat cure system comprising an alicyclic anhydride and a cationic catalyst;
c) a predominantly hydrophobic cross-linking (meth)acrylate in amounts sufficient to control the crosslinking density of the composition; and
d) a photoinitiator;
wherein the cured composition provides an optical transmittance of at least 95% and a yellowness (*b) of <1%.

2. The composition of claim 1, wherein the epoxy resin remains optically clear when exposed to temperatures of about 65° C. for about 1000 hours.

3. The composition of claim 1, having a chemical resistance in alcohol after 72 hr at 65° C. as demonstrated by block shear testing results of about 9 MPa or greater.

4. The composition of claim 3, wherein the epoxy resin is selected from the group consisting of hydrogenated bisphenol A epoxy resins, hydrogenated bisphenol F epoxy resins, cycloaliphatic epoxy resins and combinations thereof.

5. The composition of claim 1, wherein the epoxy resin is present in amounts of about 60% to about 80% based on the weight of the total composition.

6. The composition of claim 1, wherein the alicyclic anhydride is selected from the group consisting of tetrahydrophthalic anhydride (THPA), hexahydrophthalic anhydride (HHPA), methyltetrahydrophthalic anhydride (MTHPA), methylhexahydrophthalic anhydride (MHHPA), and nadic methyl anhydride (NMA).

7. The composition of claim 1, wherein the alicyclic anhydride is present in amounts of about 15% to about 30% based on the weight of the total composition.

8. The composition of claim 1, wherein the anhydride/epoxy resin ratio is about 1.1 to about 0.7.

9. The composition of claim 1, wherein the catalyst is a non-amino-containing or a non-imidazole-containing catalyst.

10. The composition of claim, wherein the catalyst is selected from the group consisting of zinc catalysts, tin catalysts and phosphine catalysts.

11. The composition of claim 10, wherein the catalyst is selected from the group consisting of Tributylmethylammoniumbromide, Tributyl(methyl)phosphonium Dimethyl Phosphate and combinations thereof.

12. The composition of claim 1, wherein the predominantly hydrophobic crosslinking (meth)acrylate is selected from the group consisting of bisphenol A ethoxylate diacrylate, polyurethane-trimethylolpropane tri(meth)acrylate, diethylene glycol di(meth)acrylate, triethylene glycol di(meth)acrylate, polyethylene glycol di(meth)acrylate, di(pentamethylene glycol)di(meth)acrylate, diglycerol diacrylate, diglycerol tetra(meth)acrylate, butylene glycol ethoxylated tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polybutadiene-polyurethane-acrylate block copolymers, polyurethane-acrylate block copolymers, polyurethane-silicone-acrylate copolymers and combinations thereof.

13. The composition of claim 1, wherein the crosslinking (meth)acrylate is present in amounts of about 15% to about 50% by weight of the total composition.

14. The composition of claim 1, wherein the photoinitiator is selected from the group consisting of benzoin ketals, hydroxyketones, acylphosphine peroxides, and combinations thereof.

15. The composition of claim 1, wherein the photoinitiator is selected from the group consisting of hydroxycyclohexyl phenyl ketone, 2,2-dimethoxyl-1,2-diphenylethyl-1-ketone; trimethylbenzoyldi-phenyl oxyphosphate, 1-hydroxylcyclohexyl benzophenone and 2-methyl1-[4-methylthiaphenyl]-2-dimethylthia-propyl-1-ketone.

16. The composition of claim 1, wherein the photoinitiator is present in amounts of about 0.05% to about 10% based on the weight of the total composition.

17. The composition of claim 1 further including an mono-(meth)acrylate selected from the group consisting of isobornyloxyethyl (meth)acrylate, isobornyl(meth) acrylate, 2-ethylhexyl(meth)acrylate, ethyldiethylene glycol (meth)acrylate, t-octyl(meth)acrylamide, diethylaminoethyl(meth)acrylate, lauryl (meth)acrylate, dicyclopentadiene (meth)acrylate, dicyclopentenyloxyethyl (meth) acrylate, dicyclopentenyl(meth)acrylate, tetrahydrofurfu ryl(meth)acrylate, 2-hydroxyethyl (meth)acrylate, 2-phenoxyethyl(meth)acrylate, butoxyethyl(meth)acrylate and combinations thereof.

18. An optical component comprising a substrate and the composition of claim 1.

19. The optical component of claim 15, wherein the optical component comprises an optical semiconductor element.

20. The optical component of claim 15, wherein the optical component comprises a display module.

21. The optical component of claim 15, wherein the optical component comprises a camera module.

22. A two part adhesive composition comprising:
a first part comprising: a saturated epoxy-functionalized compound; a cationic catalyst; a photoinitiator; and
a second part comprising: a predominantly hydrophobic crosslinking (meth)acrylate and an alicyclic anhydride,
wherein the cured composition provides an optical transmittance of at least 95% and a yellowness (*b) of <1%.

23. The composition of claim 19, wherein the first part further includes a crosslinking (meth)acrylate.

24. A method of making an adhesive composition comprising;
mixing together components comprising a saturated epoxy-functionalized compound; an alicyclic anhydride; a cationic catalyst; a predominantly hydrophobic crosslinking (meth)acrylate and a photoinitiator;
wherein the cured composition provides an optical transmittance of at least 95% and a yellowness (*b) of <1%.

25. An adhesive product formed by the process of:
(i) forming a mixture comprising a saturated epoxy-functionalized compound; a cationic catalyst; an alicyclic anhydride; a predominantly hydrophobic crosslinking (meth)acrylate and a photoinitiator;
(ii) subjecting the mixture to UV energy to cause free radical polymerization of the crosslinking (meth)acrylate to partially cure the mixture; and
(iii) further subjecting the partially cured mixture of step (ii) to heat cure to form a product having an optical transmittance of at least 95% and a yellowness (*b) of <1%.
